(19) United States
(12) Patent Application Publication
(10) Pub. No.: US 2017/0024928 A1
(43) Pub. Date: Jan. 26, 2017

(54) COMPUTER-IMPLEMENTED METHOD AND APPARATUS FOR GENERATING AN IMAGE OF A PERSON WEARING A SELECTABLE ARTICLE OF APPAREL

(71) Applicant: adidas AG, Herzogenaurach (DE)

(72) Inventors: Jochen Björn Süßmuth, Herzogenaurach (DE); Bernd C. Möller, Herzogenaurach (DE)

(21) Appl. No.: 15/217,602

(22) Filed: Jul. 22, 2016

(30) Foreign Application Priority Data
Jul. 22, 2015 (DE) 102015213832.1

(51) Int. Cl. G06T 15/50

(52) U.S. Cl. CPC G06T 15/506; G06T 2200/04; G06T 2200/08

(57) ABSTRACT

Described are computer implemented methods and systems for generating an image of a person wearing a selectable piece of apparel by accounting for the illumination condition data present in a photo of the person. The method comprises the steps of providing as inputs to a computing device a 3D person model of at least a part of the person, a photo of the person corresponding to the 3D person model, and illumination condition data relating to the photo. The method also comprises selecting a piece of apparel and generating the image as a combination of the photo and a rendered 3D apparel model of the selected piece of apparel, wherein rendering the 3D apparel model considers the illumination condition data and the 3D person model.

### CROSS REFERENCE TO RELATED APPLICATION

This application is related to and claims priority benefits from German Patent Application No. DE 10 2015 213 832.1, filed on Jul. 22, 2015, entitled “Method and apparatus for generating an artificial picture” (“the '832.1 application”). The '832.1 application is hereby incorporated herein in its entirety by this reference.

### FIELD OF THE INVENTION

The present invention relates to a method and apparatus for generating an artificial picture/image of a person wearing a selectable piece of apparel.

### BACKGROUND

On-model-product-photography is currently considered as the de-facto standard in the apparel industry for the presentation of apparel products, like T-shirts, trousers, caps etc. To this end, photos of human models are taken wearing said apparel products during a photo shooting session. The photos allow customers to immediately recognize the look, the function and the fit of the apparel product just from a single photo. Such photos are well-known from fashion catalogues, fashion magazines and the like.

Unfortunately, performing photo shootings is considerably time-consuming and expensive. The models, a photographer, a lighting technician, a make-up artist, and a hairdresser and so on all must meet in the same photo studio at the same time. Only a limited number of photos may be taken during a photo shooting session, which in turn allows only a limited number of apparels to be photographed during a photo shooting session.

Moreover, when a photo shooting session continues over several days, it is almost impossible to have the same environmental conditions, like illumination and the like, on every day of the session. Thus, the impression of the resulting photos might slightly vary, depending on the environmental conditions of the day when the individual photo was shot.

Therefore, computer-aided solutions have been developed to replace the above described photo shooting sessions.

U.S. Patent Application 2011/0298897 A1 discloses a method and apparatus for 3D virtual try-on of apparel on an avatar. A method of online fitting a garment on a person's body may comprise receiving specifications of a garment, receiving body specifications of one or more fit models, receiving one or more grade rules, receiving one or more fabric specifications, and receiving specifications of a consumer's body.

U.S. Patent Application 2014/0176565 A1 discloses methods for generating and sharing a virtual body model of a person, created with a small number of measurements and a single photograph, combined with one or more images of garments.

U.S. Patent Application 2010/0030578 A1 discloses methods and systems that relate to online methods of collaboration in community environments. The methods and systems are related to an online apparel modeling system that allows users to have three-dimensional models of their physical profile created. Users may purchase various goods and/or services and collaborate with other users in the online environment.

Document WO 01/75750 A1 discloses a system for electronic shopping of wear articles including a plurality of vendor stations having a virtual display of wear articles to be sold. First data representing a three dimensional image and at least one material property for each wear article is provided. The system also includes at least one buyer station with access to the vendor stations for selecting one or more of the wear articles and for downloading its associated first data. A virtual three-dimensional model of a person is stored at the buyer station and includes second data representative of three dimensions of the person.

A further computer-aided technique is proposed in the publication of Divivier et al.: “Topics in Realistic, Individualized Dressing in Virtual Reality”, Bundes-ministerium für Bildung und Forschung (BMBF): Virtual and Augmented Reality Status Conference 2004, Proceedings CD-ROM, Leipzig, 2004.

However, none of the above mentioned approaches has been successful to fully replace conventional photo sessions.

Therefore, the underlying object of the present invention is to provide an improved method and a corresponding apparatus for generating an image of a person wearing a selectable piece of apparel.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Systems and methods are disclosed for generating an image of a person rendered as wearing a selectable piece of apparel and accounting for lighting conditions that are present when the photo was captured while rendering the image. An apparatus for generating the said image includes, for example, a camera configured to capture a photo of the person, a scanner (e.g., a 3D scanner, depth sensor, or series of cameras to be used for photogrammetry) configured to capture a 3D person model of the person, and an ambient sensor configured to capture illumination condition data during the time in which the photo was taken. The apparatus also includes a computing device communicatively coupled to the camera, the scanner, and the ambient sensor. The person may select, via a user interface driven by the computing system, a piece of apparel from multiple pieces of apparel. The computing device generates a rendering of a 3D apparel model associated with the selected piece of apparel, determines a light layer based on the 3D person model, the 3D apparel model, and the illumination condition data, and combines the photo of the person, the rendering of the 3D apparel model, and the light layer to generate the image of the person as virtually wearing the selected piece of apparel. For example, the computing device may combine the data by composing the photo of the person as a background layer and composing the rendering of the 3D apparel model and the light layer as layers on top of the photo of the person.

To determine the light layer, the computer device determines a first model rendering that comprises the 3D person model rendered with the application of the illumination condition data. The computer device also determines a second model rendering of the 3D person model that is rendered with the application of the illumination condition data and also rendered as virtually wearing the 3D apparel model. In the second model rendering, the parts of the 3D person mode that are covered by the 3D apparel model are set to clear (e.g., by omitting the pixels not belonging to the 3D apparel model). The difference of the first model rendering and the second model rendering corresponds to the light layer. In additional embodiments, the rendering of the 3D apparel model is manipulated to match the geometric properties of the 3D person model.

### BRIEF DESCRIPTION OF THE DRAWINGS

In the following detailed description, embodiments of the invention are described referring to the following figures:

FIG. 1 depicts a flowchart for an example process for generating an image of a person wearing at least one selectable piece of apparel according to some embodiments of the present invention;

FIG. 2 depicts a 3D model of a person according to some embodiments of the present invention;

FIG. 3 depicts a person and cameras, arranged to form an example camera setup according to some embodiments of the present invention;

FIG. 4 depicts a person and a 3D scanner according to some embodiments of the present invention;

FIG. 5 depicts a person and a depth sensor according to some embodiments of the present invention;

FIG. 6 depicts a photo of a person according to some embodiments of the present invention;

FIG. 7 depicts a 3D apparel model according to some embodiments of the present invention;

FIG. 8 depicts rendered 3D apparel models according to some embodiments of the present invention;

FIG. 9 depicts a rendered 3D person model, a rendered 3D person model, wherein exemplary parts that are covered by an apparel are set to clear, and a light layer according to some embodiments of the present invention;

FIG. 10 depicts a photo of a person a light layer, a rendered 3D apparel model, an image, an image of a person wearing a 3D apparel model without a light layer, and an image of a person wearing a 3D apparel model including a light layer according to some embodiments of the present invention; and

FIG. 11 depicts a rendered 3D model and its silhouette as well as the silhouette of a person of a photo according to some embodiments of the present invention.

FIG. 12 is a block diagram depicting example hardware components for an apparatus according to some embodiments of the present invention.

FIG. 13 is a block diagram depicting example hardware components of a computing system that is part of the hardware shown in FIG. 12.

### BRIEF DESCRIPTION

According to one aspect of the invention, a method for generating artificial picture (i.e. an image) of a person wearing a selectable piece of apparel is provided, the method comprising the steps of (a) providing a 3D person model of at least a part of the person, (b) providing a photo of the person corresponding to the 3D person model, (c) providing illumination condition data relating to the photo, (d) selecting the piece of apparel, and (e) generating the artificial picture as a combination of the photo and a rendered 3D apparel model of the selected piece of apparel, wherein rendering the 3D apparel model considers the illumination condition data and the 3D person model.

Artificial pictures of an apparel-wearing person may be generated with an improved quality by rendering a 3D apparel model and combining that rendering with a photo of said human person. However, to achieve an at least partly realistic picture, a 3D model of the person may be provided, in order to use its parameters like height, abdominal girth, shoulder width and the like, for later rendering the 3D apparel model. Moreover, the present invention uses a photo of the person that replaces the 3D person model in the final artificial image. The illumination of the picture may be a further factor affecting its quality. Thus, providing illumination condition data may allow the integration of the illumination condition data into the artificial picture to further improve its quality.

By way of example, assuming that the person would have been illuminated from the upper left side while the photo has been taken, and assuming that the 3D apparel model would have been illuminated from the upper right side while rendering, this would prevent a seamless integration of the rendered 3D apparel model into the photo. The reason for this is that illumination conditions may be important when combining separately created images. If the illumination conditions of the photo and the rendered 3D apparel model significantly deviate, the shadowing and reflections on the rendered 3D apparel model and on the photo of the person also deviate from each other and therefore, may appear in an unnatural way in the artificial picture. As a result, a human viewer might be able to easily identify the generated picture as an artificial one.

Furthermore, the above described parameters with regard to the 3D person model may be used to adjust the shape of the 3D apparel model. Therefore, the rendered 3D apparel model may look like if it is worn by the person. Exact fitting of the 3D apparel model with respect to the person of the photo may further increase the quality of the generated artificial picture.

The above described results may be achieved without any tedious adjustment of a 3D scene and without any time-consuming post-production steps. In addition, even more improved results with regard to the quality of the artificial picture may be achieved by the present invention by avoiding rendering the 3D person model for usage in the artificial picture.

The above described method step e. may comprise calculating a light layer as a difference of the rendered 3D person model (without apparel product) based on the illumination condition data and the rendered 3D person model (with apparel product) based on the illumination condition data, wherein parts thereof that are covered by the 3D apparel model, are set to clear.

The difference of the two images may represent the light transport from the 3D apparel model to the 3D person model, and thus to the photo of the person.

Assume, for example, that the 3D apparel model is wearing a pair of glasses. The frame of the glasses may cause a shadow on the side of the face of the 3D person model when illuminated from said side. To calculate the light layer, the 3D person model may be rendered without wearing the glasses, and therefore without the shadow. Afterwards, the 3D person model may be rendered again, wearing the glasses, and thus including the shadow on the side of the face. However, the glasses may be set to invisible or clear during rendering. Therefore, only the rendered 3D person model with the shadow of the frame of the glasses may be shown. When calculating the difference of these two renderings, only the shadow may remain. Thus, only the shadow may be stored in the light layer.

Setting to clear may comprise omitting, by a renderer, pixels not belonging to the 3D apparel model, and/or removing said pixels during post-production.

Generating the artificial picture may further comprise layering of the photo, the light layer, and the rendered 3D apparel model.

Instead of rendering the complex 3D scene, comprising the 3D person model and the 3D apparel model, both under consideration of the illumination condition data, only a layering of the above generated parts may be required to achieve an artificial picture of good quality. Particularly, the light layer may be layered over the photo of the person. Thus, the light transport from the worn apparel to the person may be represented in the artificial picture. Then, the rendered 3D apparel model may be layered over the combination of the light layer and the photo of the person. As a result, an artificial picture of the person, “virtually” wearing the selected apparel, may be achieved.

Considering the 3D person model of step e. may comprise applying the 3D apparel model to the 3D person model and/or applying light transport from the 3D person model to the 3D apparel model.

Applying the 3D apparel model to the 3D person model may further comprise applying geometrical properties of the 3D person model to the 3D apparel model and/or applying the light transport from the 3D person model to the 3D apparel model.

Applying the geometrical properties to the 3D apparel model may allow a simulation of, e.g., the wrinkling of the fabric of the apparel, which may be a further factor for providing an artificial picture of good quality, because any unnatural behavior of the fabric, e.g. unnatural protruding or an unnatural stiffness and the like, might negatively impact the quality of the artificial picture.

Furthermore, the light transport from the 3D person model to the rendered 3D apparel model may be considered in order to improve the quality of the artificial picture. Thus, when for example, an arm or a hand of the 3D person model causes a shadow on the 3D apparel model, this shadow may also be required to be visible on the rendered 3D apparel to maintain the quality of the artificial picture.

Considering the illumination condition data of step e. may comprise applying the illumination condition data to the 3D apparel model and/or to the 3D person model.

The illumination condition data like global environmental light sources, global environmental shadows, global environmental reflections, or any other object that may impact the light transport from the environment to the 3D models may have to be represented correctly in the renderings to achieve a good quality of the artificial picture.

The step of providing a 3D person model may further comprise at least one of the following steps:

providing the 3D person model by means of a 3D scanner,

providing the 3D person model by means of a depth sensor, or

providing the 3D person model by means of photogrammetry.

In order to provide a 3D person model, a 3D scanner may be used to detect the body shape of the person. Additionally or alternatively, a depth sensor, like a Microsoft Kinect™ controller may be used. For example, by means of an algorithm, which may be based on predefined shapes of body parts, the body shape of the scanned person may be reconstructed. As a further alternative, photogrammetry may be used. By way of taking several pictures from several directions, the 3D model may be approximated. This technique may simultaneously provide the photo of the person which may be used for substituting the 3D person model in the artificial picture.

The 3D person model may comprise a silhouette and the photo may also comprise a silhouette of the person. The method may further comprise the step of bringing the silhouettes in conformity, if the silhouettes deviate from each other.

Depending on the techniques used for providing the 3D person model, it may be necessary to adjust the silhouettes such that they are in accordance with each other. Without the silhouettes being in accordance, the quality of the artificial picture may significantly suffer, since for example the calculations of the light layer may comprise some errors. When using photogrammetry, both silhouettes may automatically be in accordance since the photo of the person and the 3D person model may be generated in essentially the same point in time. Some minor tolerances in the timing may be acceptable when preventing unfavorable deviations of the silhouettes. However, when using a Microsoft Kinect™ controller or a 3D scanner, the generation of the 3D person model may require several seconds. During this time, the person may have slightly moved or may be in another breath cycle when the photo of the person is taken. Then, it may be necessary to adjust the silhouettes.

The step of bringing the silhouettes in conformity may further comprise extracting the silhouette of the person of the photo, warping the 3D person model such that the silhouette of the 3D person model matches the silhouette extracted from the photo and/or warping the photo such that it matches the silhouette of the 3D person model. To provide further flexibility, either the silhouette of the 3D person model may be warped such that it may be in accordance with the silhouette of the person of the photo, or vice versa. Warping may comprise deforming one or both of the two silhouettes. Such deformations may be realized by algorithms, e.g., configured to move the “edges” or “borders” of the silhouette until they are in accordance to each other. Warping may further comprise applying a physical simulation to avoid unnatural deformations.

Since an automated adjustment of the silhouettes may lead to unnatural deformations of either or both of the person of the photo or the 3D person model, physical simulations may be applied as a control measure. The deformations for warping may in particular unnaturally increase or decrease the size of certain parts of the body or the complete body which may negatively impact the quality of the artificial picture. Therefore, when generally considering properties of the human body (e.g., ratio of size of the hand to size of an arm) by a physical simulation, such unnatural deformations may be prevented.

The step of providing illumination condition data may be based on data gathered by an ambient sensor, in some embodiments at essentially the same point in time when the photo of the person is taken. The ambient sensor may comprise one of a spherical imaging system or a mirror ball.

Using a spherical image system, e.g., a spherical camera system, as an ambient sensor may significantly simplify providing the illumination condition data. Such an image system may capture a 360° panorama view that surrounds the person during generation of the corresponding 3D person model and/or the photo of the person. As a result, relevant light sources and objects and the like that surround the set may be captured and stored in a panorama image. Note that it is for example also possible to capture only a part or parts of the 360° panorama view, e.g. 180° or any other suitable amount of degree. Similar results may be achieved if a mirror ball is used.

Providing the illumination condition data essentially at the same point in time may ensure that the illumination conditions are not only in accordance with the photo, but also with the 3D person model that may be generated at the point in time when the photo of the person is taken. Thus, all three components—the photo of the person, the illumination condition data, and the 3D person model—may be in accordance with each other. Therefore, providing the illumination condition data at the point in time when the photo is taken may allow using said data later-on for rendering the selected piece of apparel. Particularly, when rendering a 3D model of the selected piece of apparel and at the same time considering the illumination condition data as well as the 3D model of the person may enable the method to adjust the rendered 3D apparel model to the body proportions of the model and to the same illumination conditions while the photo of the person has been taken.

In detail, considering the illumination condition data may enable an essentially seamless integration of the rendered, illuminated 3D apparel model into the photo of the person which may significantly improve the quality of the artificial picture.

The term “essentially at the same time” means at the same point in time, but including typical time tolerances that are inevitable in the addressed field of technology.

The illumination condition data may comprise an environment map. The environment map may comprise a simulated 3D model of a set in which the photo has been taken.

The above described panorama view, e.g., stored in terms of a digital photo, may be used as an environmental map. In more detail, the digital image may be used to surround the 3D apparel model and/or the 3D person model. Then, the light transport from the environmental map to the 3D models may be calculated.

Alternatively, a modelled 3D scene that represents the set in which the photo of the person has been taken may be used, at least in part, as the environmental map. This solution may avoid the usage of an ambient sensor for detecting or providing the illumination condition data and may simplify the setup of components required for creating the artificial picture and/or the 3D model.

Applying the illumination condition data may comprise considering light transport from the environment map to the 3D person model and to the 3D apparel model.

As already discussed above, the environmental map may be used to calculate the light transport from the environmental map to the 3D models to achieve the artificial picture of good quality.

The 3D person model may comprise textures. Furthermore, the textures may be based on at least one photo of the person taken by at least one camera.

To use a textured 3D model of the person may further improve the quality of the renderings as described above, and therefore also of the artificial picture. This is because a textured 3D person model may allow a more accurate calculation of the light transport from said model to the 3D apparel model. The more accurate the calculation, the better may be the results of the artificial picture regarding its quality. For example, when a piece of apparel comprises reflecting parts like small mirrors and the like, in which the 3D person model is (at least in part) visible, the rendering results of the 3D apparel model may be improved since an accurate reflection of the surface of the 3D person model may be calculated.

The method may comprise the step of storing parameters of the at least one camera, wherein the parameters may comprise at least one of the position of the camera, the orientation, and the focal length. Furthermore, the parameters may be suitable to calculate a reference point of view wherein step e. (defined above) may consider the reference point of view.

Storing the above listed parameters may allow an automated layering of the light layer and the rendered 3D apparel model over the photo of the person such that the resulting artificial picture may look as if the person is wearing the rendered apparel. In more detail, when said parameters are known and passed to a renderer, the resulting rendered image of the 3D apparel model and the calculated light layer may fit on top of the photo of the person, such that it seems as if the person is wearing the apparel. This is, since the renderer may position its virtual camera at the position corresponding to the camera used for taking the photo of the person. In addition, when considering the focal length and the orientation, the view of the renderer's camera may be even more in accordance with the camera used for taking the photo of the person. As a result, all rendered images (or parts of them) may be rendered from the same or a similar perspective as the photo of the person that has been taken. Therefore, no further (e.g., manual) adjustment of the images may be necessary for layering the rendering results over the photo of the person. This leads to a significant simplification of the described method.

The photo and the 3D person model may show the person in the same pose.

Having the same pose further simplifies the layering of the rendering over the photo of the person which may avoid any further adjustment. Any adjustment may bear the risk to negatively impact the quality since adjustments may lead to any unnatural deformations and other deficiencies.

A further aspect of the present invention relates to an apparatus for generating an artificial picture of a person wearing a selectable piece of apparel, the apparatus comprising (a) means for providing a 3D person model of at least a part of the person, (b) means for providing a photo of the person corresponding to the 3D person model, (c) means for providing illumination condition data relating to the photo, (d) means for selecting the piece of apparel, and (e) means for generating the artificial picture as a combination of the photo and a rendered 3D apparel model of the selected piece of apparel, wherein rendering the 3D apparel model considers the illumination condition data and the 3D person model.

Such an apparatus may simplify performing a method according to one of the above described methods. For example, such an apparatus may replace a photo studio. Furthermore, the apparatus may be designed in a way such that it may be controlled by just one single person. Moreover, such an apparatus may be controlled by the person from which a photo shall be taken and from which a 3D model shall be created.

The means of the apparatus for providing a 3D person model of at least a part of the person may comprise at least one of a 3D scanner, a depth sensor, and/or a plurality of photogrammetry cameras.

The means of the apparatus for providing a photo of the person corresponding to the 3D person model may comprise a camera.

The camera of the means for providing a photo of the person may be one of the photogrammetry cameras.

The means of the apparatus for providing illumination condition data relating to the photo may comprise an ambient sensor, wherein the ambient sensor may comprise at least one of a spherical imaging system, or a mirror ball.

The means of the apparatus for selecting the piece of apparel may comprise at least one or more of a user interface, a database, and/or a file.

Such an interface allows an easy selection of the piece of apparel, wherein the apparel may be stored in a database and/or a file. Moreover, more than one apparel may be selected from the database and/or from a file. Therefore, more than one piece of apparel may be processed by method step e. at the same time. As a result, the artificial picture may show a person wearing more than one piece of apparel at once.

The means of the apparatus for generating the artificial picture may be configured to generate an artificial picture of a person wearing a selectable piece of apparel according to the above described methods.

A further aspect of the present invention relates to a computer program that may comprise instructions for performing any of the above described methods.

A further aspect of the present invention relates to an artificial picture of a person wearing a selectable piece of apparel, generated according to any of the above described methods.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

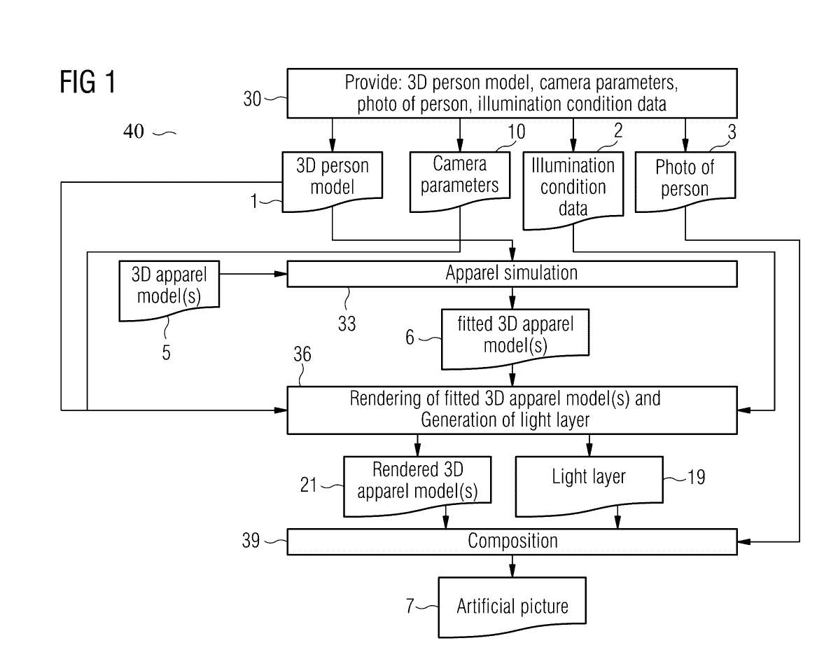

FIG. 1 shows a process 40 according to some embodiments of the present invention. It is to be understood that process 40 may comprise any or all of the process steps 30, 33, 36, and 39. However, the process steps 30, 33, 36, and 39 may be reordered, some of the process steps 30, 33, 36, and 39 may be merged or omitted. In addition, further process steps (not shown) may be integrated into process 40 or in the single process steps 30, 33, 36, and 39.

The process 40 is intended to generate an artificial picture 7 according to some embodiments of the present invention. The artificial picture 7 comprises a computer-generated image that provides a photorealistic impression of the person rendered as wearing a selected article of clothing. The artificial picture 7 may be composed of several layers, wherein the layers may comprise a photo of a person 3, a light layer 19, and at least one rendered 3D apparel models 21. The artificial picture 7 may be of photorealistic nature. The terms “photorealistic nature”, “photorealism”, “realistic” etc. with respect to the artificial picture 7 may be understood as providing an impression like a real photo. However, specific tolerances may be acceptable. For example, tolerances may be acceptable as long as a human viewer of the artificial picture 7 may have the impression that he looks at a real photo, e.g., taken by means of a camera, while some components are indeed not realistic. In more detail, the above given terms are herein to be understood as giving the impression to a human viewer to look at a “real” photo, while at the same time (e.g., recognizable by a detailed examination of the artificial picture) some parts of the artificial picture 7 may look like to be synthetically constructed and there-fore may not be an exact representation of reality.

For example, in some instances, the tracing of light rays that may be reflected by 3D models to be rendered, may be limited to a certain number of reflections. Such a limitation, e.g., controlled within a rendering software (also called “renderer”), may significantly optimize (e.g., reduce) computational time for rendering the 3D apparel model 5, with the effect that some parts of the rendering may not look like exactly representing reality. However, a viewer may not be able to distinguish between rendered 3D models with and without a limited number of ray reflections. Thus, the viewer may still have a photorealistic impression when looking at such a rendering.

To achieve such a photorealistic impression, several aspects, explained in the following with respect to process 40, may have to be considered when generating an artificial picture 7 according to some embodiments of the present invention.

The process 40 may comprise process step 30 of providing a 3D person model 1, camera parameters 10, illumination condition data 2, and/or a photo of a person 3.

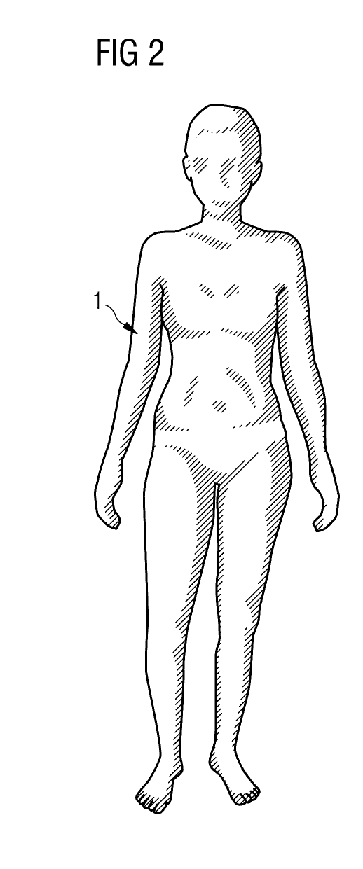

An exemplary 3D person model 1 according to some embodiments of the present invention is shown in FIG. 2. The 3D person model 1 may be provided in process 30 of FIG. 1. The 3D person model 1 may be a 3D representation of a human person 11. The 3D person model 1 may be a detailed representation of the shape of the body of the corresponding person 11, on which the 3D person model 1 is based on. The 3D person model 1 may, for example, comprise a specific amount of points which are connected to each other and thus may form polygons. However, the detail degree may vary. Therefore, the 3D person model 1 may comprise a number of polygons. Commonly, the detail degree may be increased when more polygons are used to form the 3D person model 1. 3D models are generally known by the person skilled in the art, e.g., from so called 3D modelling software, like CAD software and the like. The 3D person model 1 may comprise textures or may comprise a synthetic surface (without textures, as shown in FIG. 1), e.g., comprising a single-colored surface.

Note that the 3D person model 1 is not limited to shapes of human bodies. Moreover, 3D models of, for example, animals and objects are suitable to comply with some embodiments of the present invention.

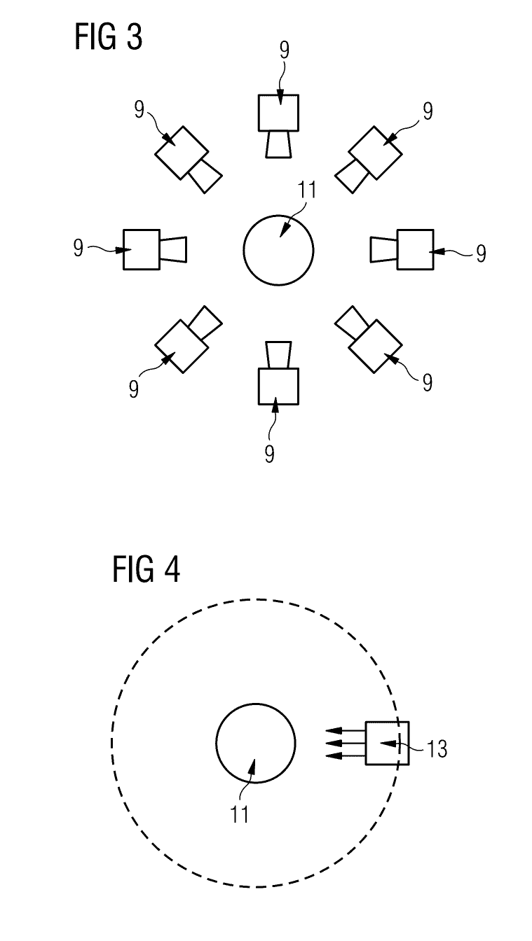

The 3D person model 1 may be generated by photogrammetry cameras 9, exemplarily shown in FIG. 3 according to some embodiments of the present invention. The photogrammetry cameras 9 may surround the person 11. All cameras 9 take a picture of the person 11 at the same point in time, wherein the term “same point in time” is to be understood such that tolerances are permitted, as already defined above. The tolerances are to be seen in a range as it commonly occurs when several cameras are triggered at the same time, e.g. resulting from signal runtime of the trigger signal and the like.

Afterwards, for example, the 3D person model 1 may be constructed based on the taken pictures using, e.g., photogrammetry algorithms. In more detail, photogrammetry is a technique for making measurements from photographs for, inter alia, recovering the exact positions of surface points. Thus, this technique may be used to reconstruct the surface points of the person 11 to construct a corresponding 3D person model 1.

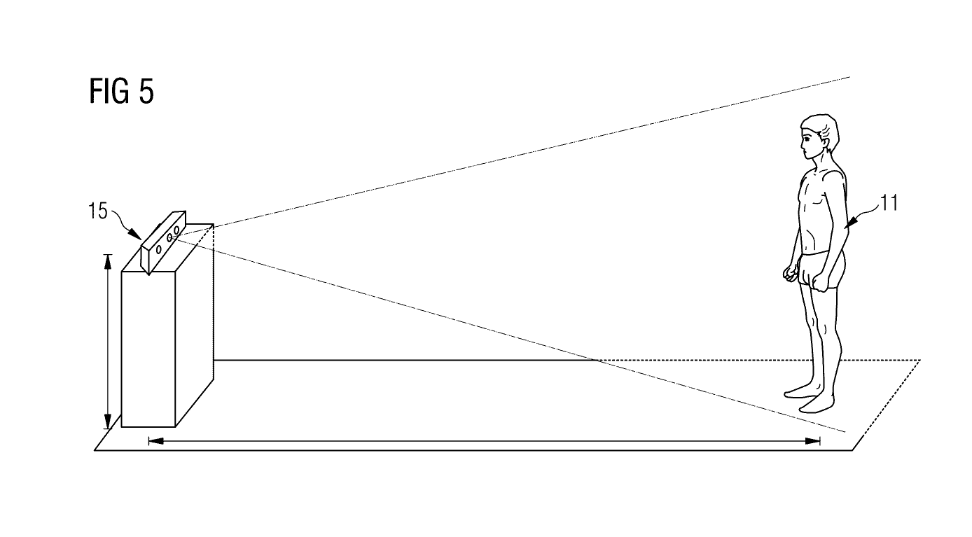

Additionally or alternatively, the 3D person model 1 may be generated by a 3D scanner 13 according to some embodiments of the present invention as shown in FIG. 4. A 3D scanner 13 may scan the shape of the body of a person 11 and may store the results of scanned surface points in terms of a 3D person model 1.

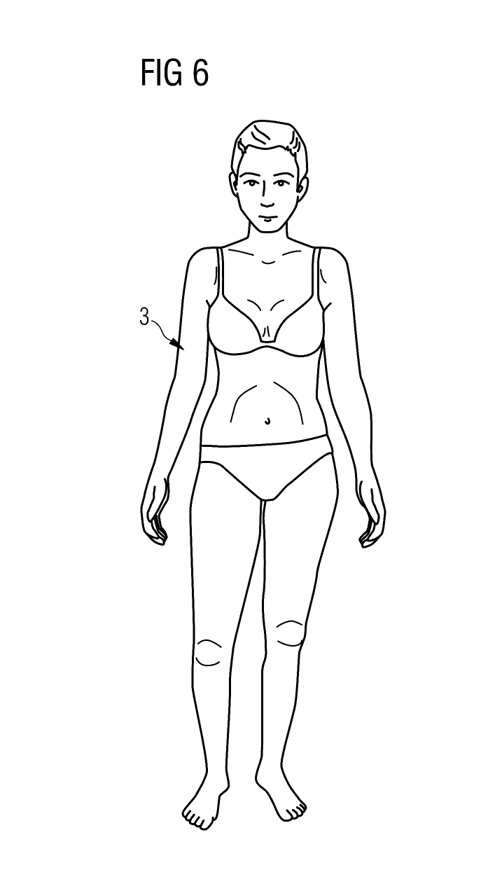

Additionally or alternatively, the 3D person model 1 may be generated by a depth sensor 15 according to some embodiments of the present invention as shown in FIG. 5. A depth sensor 15 may, for example, be a Microsoft Kinect™ controller. Such a controller may project an irregular pattern of points within the infrared spectrum into a “scene”. The corresponding reflections may then be tracked by an infrared camera of the controller. By considering the distortion of the pattern, the depth (the distance to the infrared camera) of the single points may then be calculated. To construct a 3D person model 1 of said points, a deformation is applied to at least one available standard model.

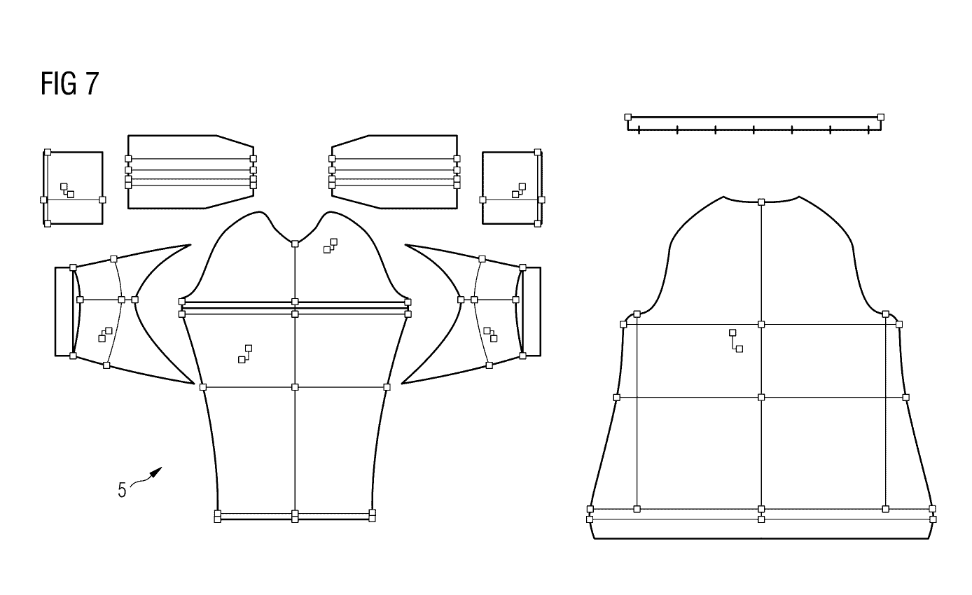

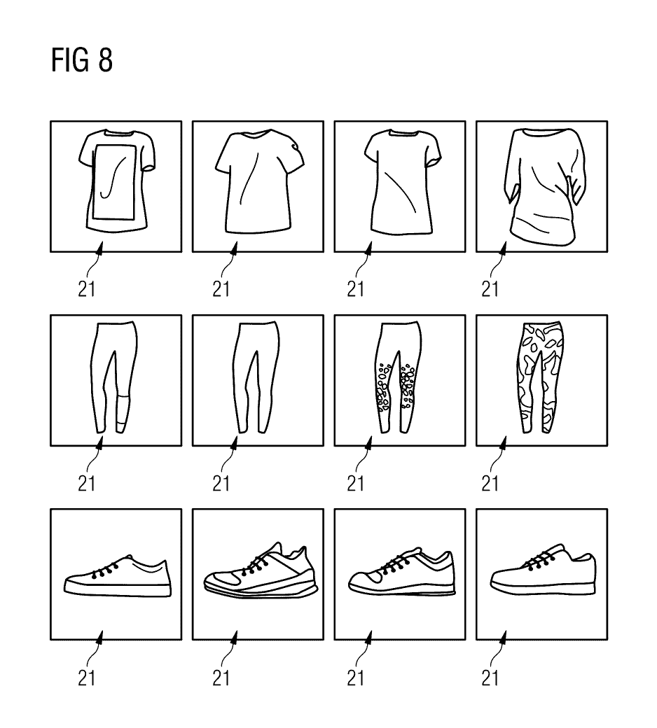

An exemplary photo of a person 3 according to some embodiments of the present invention is shown FIG. 6. The person 11 may be the same person 11 as used for generating the above described 3D person model 1. The photo of the person 3 may be taken by means of a camera 9, e.g., a digital camera, camcorder etc. The camera 9 may be for example one of the photogrammetry cameras 9 as described above with respect to FIG. 3. The resolution of the photo of the person 3 may vary. The higher the resolution, the higher the detail degree of the photo of the person 3 which may then result in a photo 3 of better quality. The photo 3 may be taken such that the photo of the person 3 shows the person 11 in a pose according to the 3D person model 1. However, deviations may be acceptable since they might be corrected and/or adjusted afterwards (described further below). The camera 9 utilized to take the photo of the person 3 may comprise camera parameters 10 like position, orientation, and/or focal length. The camera parameters 10 may be stored or saved such that they may be reused in one of the other process steps 33, 36, and/or 39.

Note that the photo of the person 3 is not limited to human persons 11. Moreover, photos of, for example, animals and objects are suitable to comply with some embodiments of the present invention.

The photo of the person 3 may be taken when specific illumination conditions prevail. For example, the person 11 shown in the photo 3 may be illuminated from a specific angle, from specific direction, and/or from a specific height. For example, illumination elements like one or more spot lights, mirrors, and/or mirror-like reflectors may be used to illuminate the person 11 when the photo 3 is taken. Thus, light rays may be directed to the person to create an illuminated “scene”. Such an illumination may be known from photo studios, wherein one or more of the above described illumination elements may be used to illuminate a “scene”, e.g., comprising the person 11, from which the photo 3 may then be taken.

The illumination condition data to be provided may be detected by an ambient sensor like a spherical image system and/or a mirror ball. For example, a spherical image system may be based on a camera which may be able to create 360° panorama picture of the environment that surrounds the person 11 during generation of the corresponding 3D person model 1. As a result, relevant light sources and objects and the like that surround the set may be captured and stored in a panorama image. Note that it is for example also possible to capture only a part or parts of the 360° panorama view, e.g. 180° or any other suitable amount of degree. For example, a spherical image system like the Spheron™ SceneCam may be used. Note that similar results may be achieved if a mirror ball is used instead of a spherical image system.

Process step 33 of process 40 may perform a simulation of the 3D apparel model(s) 5. In this process step 33, the 3D apparel model(s) 5 may be simulated, e.g., by applying geometrical properties of the 3D person model 1 like height, width, abdominal girth and the like to the 3D apparel model(s) 5.

An exemplary 3D apparel CAD model 5 according to some embodiments of the present invention is shown in FIG. 7. A 3D apparel model 5 may comprise, but is not limited to 3D models oft-shirts, trousers, shoes, caps, glasses, gloves, coats, masks, headgear, capes etc. In general, a 3D apparel model 5 may correspond to any kind of garment or device, e.g. glasses, prosthesis etc., wearable by a (human) person 11.

A 3D apparel model 5 may comprise polygons, lines, points etc. 3D apparel models are generally known by the person skilled in the art, e.g., from so called 3D modelling software, like CAD software and the like.

The 3D apparel model 5 may comprise textures or may comprise a single or multicolored surface (without textures), or a combination of it. Thus, a texture may be applied later to the 3D apparel model, or the color of the surface may be adjusted. In addition, a combination of a color and a texture may be possible in order to design the surface of the 3D apparel model 5.

The 3D apparel model may also comprise information of fabrics which may be intended for manufacturing a corresponding piece of apparel.

The above mentioned apparel simulation 33 may be performed by a cloth simulation tool like V-Stitcher, Clo3D, Vidya etc. However, other software components may be involved in such a process. The simulation may adjust the 3D apparel model(s) 5 to get in accordance with the above mentioned geometrical properties of the 3D person model 1. During simulation, physical characteristics of the fabric (or a combination of fabrics) may be considered. For example, a fabric like silk wrinkles in a different way than wool and the like. Thus, the simulation may be able to calculate how to modify the 3D apparel model(s) 5 such that they get in accordance with the shape of the body provided by the 3D person model 1 under consideration of physical properties of the fabric(s), intended for manufacturing. Physical properties may comprise, but are not limited to, thickness of the fabric, stretch and bending stiffness, color(s) of the fabric, type of weaving of the fabric, overall size of the 3D apparel model 5 etc.

Note that more than one 3D apparel model 5 may be passed to the cloth simulation tool. Thus, the simulation may be applied to at least one apparel at the same time. For example, one t-shirt and one pair of trousers may be selected. Then, the cloth simulation tool may simulate both 3D apparel models 5 according to the above given description.

As a result, process step 33 may generate the fitted 3D apparel model(s) 6 that may look like being worn by a (human) person 11.

In addition or alternatively, the 3D apparel model(s) 5 may be stored in a data-base, eventually together with an arbitrary number of other 3D apparel models 5. In addition or alternatively, the 3D apparel model(s) 5 may be stored in a file, e.g., a computer or data file. The 3D apparel model(s) 5 may be selected from a database or a file (or from any other kind of memory) by utilizing a user interface. Such a user interface may be implemented in terms of a computer application, comprising desktop applications, web-based applications, interfaces for touchscreen applications, applications for large displays etc. In addition or alternatively, a user interface may comprise physical buttons, physical switches, physical dialers, physical rocker switches etc. The selection may be used to pass the 3D apparel model(s) 5 to a corresponding simulator according to process step 33.

Note that the 3D apparel model(s) 5 is/are not limited to garments for human persons. Moreover, for example, garments for animals or fabrics that may be applied to any kind of object are suitable to comply with some embodiments of the present invention.

Process step 36 of process 40 may perform one or more rendering steps, using a renderer and/or a 3D rendering software. During rendering, the 3D person model 1, the fitted 3D apparel model(s) 6, and the illumination condition data 2 may be considered. Process step 36 may at least serve the purpose of rendering the fitted 3D apparel model(s) 6 and to provide a light layer 19. Note that one or more light layers 19 may be provided. For example, when more than one fitted 3D apparel model 6 is rendered, the light transport from each fitted 3D apparel model 6 to the 3D person model 1 may be stored in a separate light layer 19.

Before rendering, a reference point of view may be calculated according the camera parameters 10. This reference point of view may then be used for positioning and orienting a virtual camera according to the position and orientation of the camera used for taking the photo of the person 3. Using such a reference point may allow to perform all rendering steps in a way such that the perspective of the rendering results comply with the perspective from which the photo of the person 3 has been taken. Thus, a composition (explained further below) of the renderings and the photo of the person 3 may be simplified.

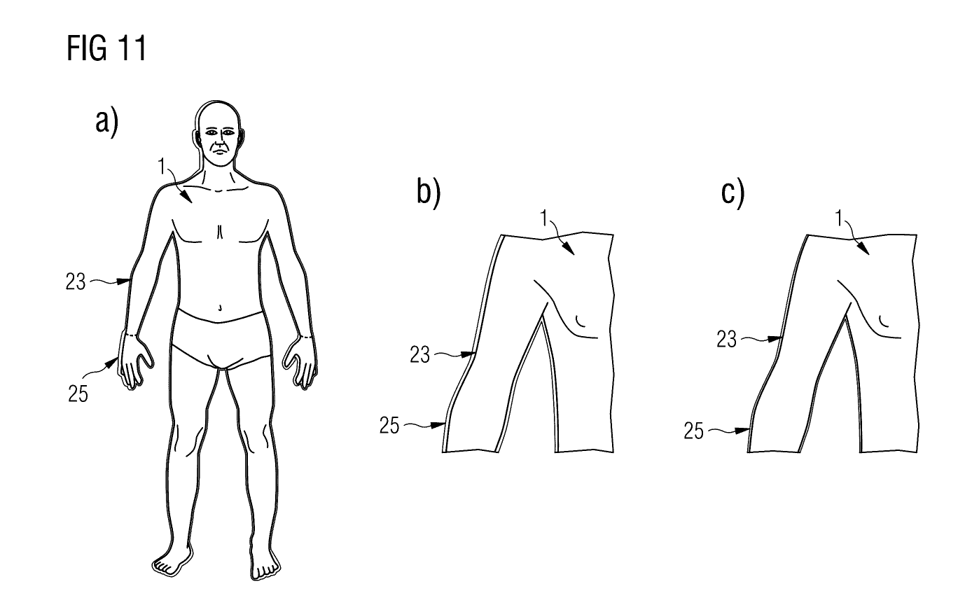

Additionally or alternatively, FIG. 11 shows a silhouette 23 of the 3D person model 1 and a silhouette 25 of the photo of the person 3 (FIG. 11(a)). Depending, e.g., on the accuracy of the generation of the 3D person model 1 and/or the photo of the person 3, the silhouettes 23, 25 may deviate (FIG. 11(b)). This may, for example, arise when the photo of the person 3 is not taken at the point in time when the 3D person model is generated. Such a deviation may be compensated by warping one or both of the silhouettes 23, 25 such that they are in accordance with each other after warping (FIG. 11(c)).

In more detail, the warping may be done by deforming the silhouettes 23, 25. Such deformation may be realized by algorithms, e.g., configured to move the “edges” or “borders” of the silhouettes 23, 25 as long as they are not in accordance with each other. Edges may, for example, be detected by using the Sobel operator-based algorithm which is a well-known edge detection algorithm. In addition, warping may further comprise applying a physical simulation to avoid unnatural deformations. This may avoid that specific parts of the body, either shown in the photo of the person 3 or represented by the 3D person model 1, deform in an unnatural way. For example, when specific parts are changed in size, this may lead to an unnatural impression. In more detail, when for example, a hand is enlarged during deforming such that it notably exceeds the size of the other hand, this may lead to an unnatural deformation, as mentioned above. When applying such a physical simulation to the process of warping, such deformations may be prevented. Corresponding warping algorithms may therefore be in knowledge of properties of the human body and the like and may consider these properties during warping the silhouettes.

Rendering the fitted 3D apparel model(s) 6 may be based on the 3D person model 1 and on the illumination condition data. The 3D person model 1 and the fitted 3D apparel model(s) 6 scene may be arranged such that the 3D person model 1 virtually wears the fitted 3D apparel model(s) 6. Then, the illumination condition data 2 may be applied to both 3D models 1, 6.

Applying the illumination condition data 2 may comprise surrounding the 3D person model 1 and the fitted 3D apparel model(s) 6 by an environmental map. For example, a virtual tube may be vertically placed around the 3D models such that the 3D person model 1 and the fitted 3D apparel model(s) 6 are inside the tube. Then, the inner side of the virtual tube may be textured with the environmental map, e.g., in form of a digital photo. A camera—representing the perspective from which the 3D models may be rendered—may be placed inside the tube so that the outer side of the tube is not visible on the rendered image of the 3D models 1, 6. Texturing the inner side of the tube with the environmental map may apply the light transport from the texture to the 3D models 1, 6. Accordingly, the 3D models 1, 6 may be illuminated according the environmental map. Note that, additionally or alternatively, other techniques known from the prior art may be suitable to utilize an environmental map to illuminate 3D models 1, 6. For example, some renderers may accept an environmental map as an input parameter such that no explicit modelling—as describes with respect to the above mentioned tube—is required.

Additionally or alternatively, a 3D scene, representing the environment in which the photo of the person 3 has been taken may be provided to substitute or to complement the environmental map. In this instance, the 3D person model 1 and the fitted 3D apparel model(s) 6—worn by the 3D person model 1—may be placed with in 3D scene representing the environment in which the photo of the person 3 has been taken. Thus, the 3D person models 1 and the fitted 3D apparel model(s) 6 may be located in the 3D scene representing the environment. As a result, light transport from the 3D scene to the 3D models 1, 6 may be calculated.

Using a 3D scene which may have been, for example, manually modelled, avoids the usage of an ambient sensor for generating the environmental map. Thus, the setup for generating the photo of the person 3 and/or the 3D person model 1 is significantly simplified.

The fitted 3D apparel model(s) 6 may be rendered while the 3D person model 1, virtually wearing the fitted 3 apparel model(s) 6, is set to clear. Such a rendering technique may consider the light transport from the 3D person model 1 (even it is set to clear) to the fitted 3D apparel model(s) 6. For example, shadows caused by the 3D person model 1 (which may occur from the lighting of the environmental map) may be visible on the rendered 3D apparel model(s) 21. Also, any other light transport (like reflections etc.) from the 3D person model 1 to the fitted 3D apparel model(s) 6 may be visible on the rendered 3D apparel model(s) 21. As a result, the rendered 3D apparel model(s) 21 may be considered as a 2D image, wherein only parts of the fitted 3D apparel model(s) 6 are visible which are not covered by the 3D person model 1. Therefore, for example, the part of the back of the collar opening of a worn t-shirt may not be shown in the rendered 3D apparel model 21 since it may be covered by the neck of the 3D person model 1. Such a rendering technique may ease the composition (described further below) of the photo of the person 3 and the rendered 3D apparel model(s) 21.

However, for example, a renderer may not support rendering the fitted 3D apparel model(s) 6 while the 3D person model 1 is set to clear. In such a case, the pixels in the image of the rendered 3D apparel model(s) 21 that do not belong to the rendered 3D apparel model(s) 21 may be masked after rendering. These pixels may, e.g., relate to the 3D person model 1 or to any other environmental pixels. Masking may be understood as to remove the pixels from the image, e.g., by means of an image processing software like Photoshop™ etc. during post-production or the like.

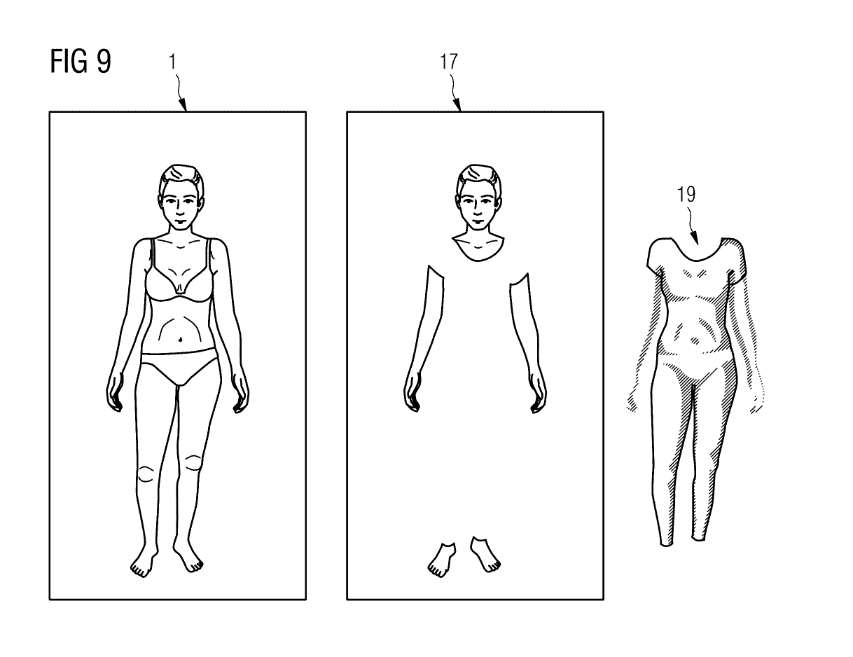

Additionally or alternatively, within process step 36, a light layer 19 is calculated and may be stored in form of a 2D image. As shown in FIG. 9 according to some embodiments of the present invention, the 3D person model 1 may be rendered without wearing the fitted 3D apparel model(s) 6. Afterwards, the 3D person model 1 may be rendered again, but this time wearing the fitted 3D apparel model(s) 6. However, parts of the 3D person model 1 that are covered by the fitted 3D apparel model(s) 6 may be set to clear. A rendered 3D person model 1 with a worn apparel set to clear 17 may then only show parts that are not covered by the worn fitted 3D apparel model(s) 6. Note that a corresponding renderer may still consider the light transport from the worn fitted 3D apparel model(s) 6 to the 3D person model 1. When calculating the light layer 19, the difference between the two renderings is calculated resulting in a light layer 19 that may only show the transported light (shadows, reflections) from the fitted 3D apparel model 21 to the 3D person model 1. The light layer thus, in some embodiments, corresponds to the pixels that form the transported light rendering (e.g., shadows, reflections) resulting from the difference between the first 3D person model rendering not wearing the fitted 3D apparel model and the second 3D person model rendering wearing the fitted 3D apparel model with the covered parts of the 3D person model set to clear.

Note that it is also possible to render a light layer 19 for each fitted 3D apparel model 6 separately.

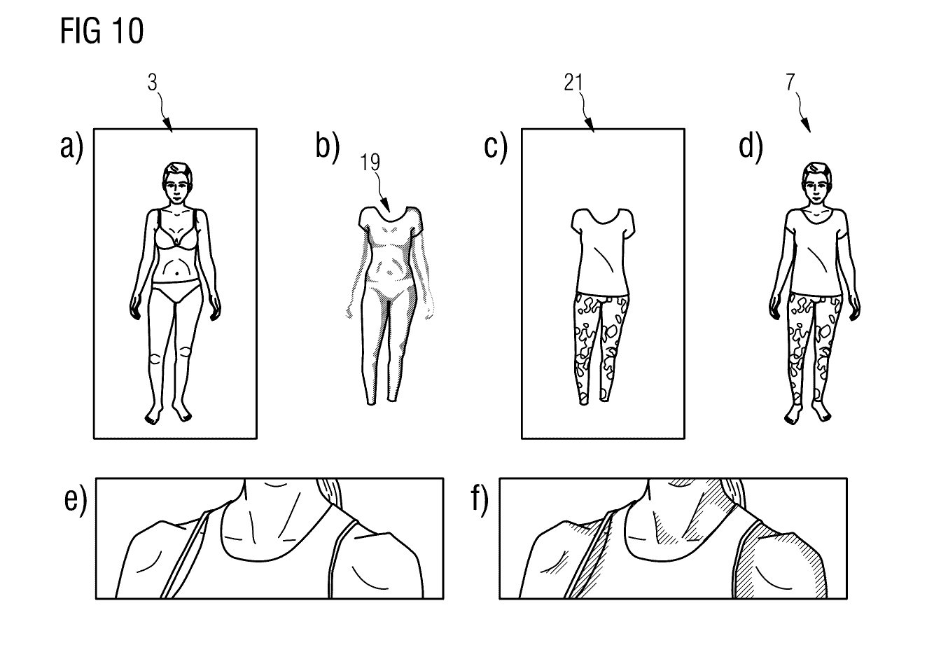

Process step 39 of process 40 may perform a composition of the photo of the person 3 (FIG. 10,(a)), the light layer 19 (FIG. 10(b)), and rendered 3D apparel model(s) 21 (FIG. 10(c)), wherein these components are shown in FIG. 10 according to some embodiments of the present invention. A composition may, for example, be a layering in which the photo of the person 3 is used as the background. Then, over the photo of the person 3, the light layer 19 may be layered. When more than one light layer 19 has been calculated, these light layers 19 may be layered over each other. After that, the rendered 3D apparel model(s) 21 may be layered over the combination of the photo of the person 3 and the light layer(s) 19. Such a composition may then result in the artificial picture 7 (FIG. 10(d) and FIG. 10(f)).

Thereafter, the artificial picture 7 may show a person 11, wearing at least one piece of apparel. The artificial picture 7 may comprise such a quality that a human viewer may believe that the artificial picture is a photo, e.g., taken by a camera.

Therefore, artificial picture 7 may be of photorealistic nature. This may be because all components of the picture may comply in size, perspective and illumination. In particular, this may result from applying the geometrical properties of the 3D person model 1 to the 3D apparel model 6 and from performing a simulation of said 3D model. Additionally or alternatively, the photorealistic impression may arise from considering the light transport from the 3D person model 1 to the 3D apparel model(s) 6, and vice versa.

The difference between an artificial picture 7 comprising a photorealistic nature and an artificial picture 7 without a photorealistic nature is exemplarily shown in FIG. 10(e) and FIG. 10(f). As can be seen, FIG. 10(e), showing a portion of an artificial picture without photorealistic nature, does not comprise any shadows or light transport from the 3D apparel model 6 to the 3D person model 1. In contrast, FIG. 10(f), showing the same portion as presented in FIG. 10(e), comprises shadows and light transport. As can be seen, FIG. 10(e) does not provide a photorealistic nature, whereas FIG. 10(f) does.

According to some embodiments of the present invention, process 40 may also be utilized in a so-called virtual dressing room. A customer who wants to try-on several apparels may generate a 3D person model and a photo 3 of himself, as described above. Then, e.g., a screen or display or the like (e.g. located in an apparel store) may display the photo 3. The customer may then select apparels, e.g., utilizing above described user interface, which may then be generated and layered over the photo according to process 40. Such a method may save time during shopping of apparels since the customer has not to personally try-on every single piece of apparel.

According to some embodiments of the present invention, process 40 may be used to realize an online apparel shopping portal. A customer may once generate a 3D person model and a photo 3 as described above, for example in a store of a corresponding apparel merchant that comprises apparatus according the present invention. The 3D person model 1 and the photo of the person 3 may then be stored such that they may be reused at any time, e.g., at home when visiting the online apparel shopping portal. Therefore, some embodiments of the present invention may allow to virtually “try-on” apparels at home when shopping apparels at online apparel shopping portals.

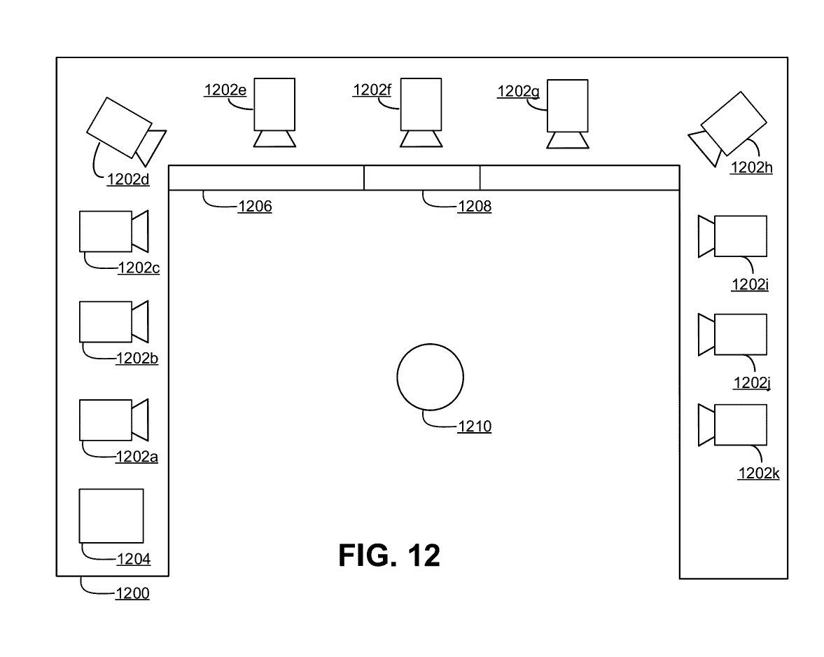

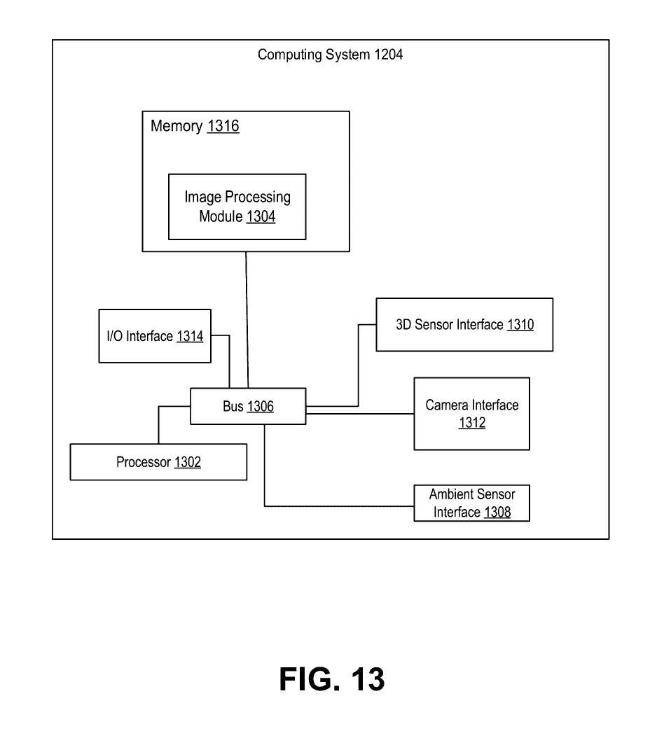

FIGS. 12 and 13 are block diagrams depicting example hardware implementations for an apparatus that generates an image of a person wearing a selected piece of apparel via the process discussed above. FIG. 12 shows a block diagram for the apparatus as it is implemented in a room, such as a virtual dressing room or a photo studio. The apparatus includes an enclosure 1200 that may have embedded components for capturing the 3D person model, the photo of the person, and the illumination condition data associated with the photo. The enclosure 1200 is shown as a cubicle like enclosure for illustrative purposes, but it should be understood that embodiments herein also cover enclosures with other geometric shapes. For example, enclosure 1200 may have a circular or spherical layout to allow components within to capture the 3D person model, photo of the person, and illumination condition data as a 360-degree image capture process. Other layouts for the enclosure 1200 are also possible.

The enclosure 1200 includes one or more of a plurality of sensing devices 1202a-1202k. The sensing devices 1202a-k are shown for illustrative purposes to demonstrate how sensing means may be arranged in the apparatus. For example, in some embodiments, enclosure 1200 may include one sensing device 1202a that is configured as a 3D scanner that rotates around a user that entered the enclosure 1200 in a circular pattern to capture the 3D person model of the user (as discussed above with respect to FIG. 4). The enclosure 1200 may also include a second sensing device 1202f that is a camera module that captures a photograph of the user that entered the enclosure 1200. The enclosure 1200 may also include a sensing device 1210 as a spherical imaging system or a mirror ball for capturing the illumination condition data. The sensing device 1210 may be suspended from the ceiling of the enclosure or be part of the enclosure itself In other embodiments, the sensing device 1210 for capturing the illumination condition data may be embedded within the enclosure 1200, similar to sensing devices 1202a-k.

In other embodiments, enclosure 1200 may include multiple sensing devices 1202a-k configured as camera devices. In such embodiments, sensing devices 1202a-k capture multiple photographs of the user as provide a 3D person model via photogrammetry processing as discussed above. One of the sensing devices 1202a-k may also be used as a standard camera for providing the photo of the person.

Enclosure 1200 also includes a display 1206 and a user interface 1208. The user may provide inputs into the user interface 1208 for selecting one or more pieces of apparel from a plurality of apparel selections. The user interface 1208 may be any standard user interface including a touch screen embedded in the display 1206. The display 1206 may comprise any suitable display for displaying the photo of the person and the resulting image of the person wearing the selected piece of apparel as selected by the user via user interface 1208.

The enclosure 1200 also includes a computing system 1204. The computing system is communicatively coupled to the sensing devices 1202a-k and the sensing device 12010 and includes interfaces for receiving inputs from the sensing devices 1202a-k, 12010. The computing system 1204 includes the software for receiving the captured 3D person model (e.g., as CAD data), the photo of the person, and the ambient sensed data indicating the illumination condition data. The software for the computing system 1204 also drives the user interface 1208 and the display 1206 and receives the data indicating the user selection of the apparel. The software for the computing system 1204 processes the received inputs to generate the photorealistic image of the person wearing the selected apparel via the processes described in detail above.

FIG. 13 is a block diagram depicting example components that are used to implement computing system 1204. The computing system 1204 includes a processor 302 that is communicatively coupled to a memory 1316 and that executes computer-executable program code and/or accesses information stored in the memory 1316. The processor 1302 comprises, for example, a microprocessor, an application-specific integrated circuit (“ASIC”), a state machine, or other processing device. The processor 1302 includes one processing device or more than one processing device. Such a processor is included or may be in communication with a computer-readable medium storing instructions that, when executed by the processor 1302, cause the processor to perform the operations described herein.

The memory 1316 includes any suitable non-transitory computer-readable medium. The computer-readable medium includes any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions include processor-specific instructions generated by a compiler and/or an interpreter from code written in any suitable computer-programming language, including, for example, C, C++, C#, Visual Basic, Java, Python, Perl, JavaScript, and ActionScript.

The computing system 1204 also comprises a number of external or internal interfaces for communicating with and/or driving external devices. For example, computing system 1204 includes an I/O interface 1314 that is used to communicatively coupled the computing system 1204 to the user interface 1208 and the display 1206. The computing system 1204 also includes a 3D sensor interface 1310 for interfacing with one or more sensing devices 1202a-1202k that are configured as 3D scanners, cameras for photogrammetry, or other types of 3D sensors. The computing system 1204 also includes a camera interface that is used to communicatively couple the computing system 1204 to a sensing device 1202f that may be configured as a camera device for capturing the photo of the person. The computing system 1204 also includes an ambient sensor interface 1308 that is used to communicatively couple the computing system 1204 to the sensing device 1210 for receiving the illumination condition data. The 3D sensor interface 1310, camera interface 1312, ambient sensor interface 1380, and the I/O interface 1314 are shown as separate interfaces for illustrative purposes. The 3D sensor interface 1310, camera interface 1312, ambient sensor interface 1380, and the I/O interface 1314 may be implemented as any suitable I/O interface for a computing system and may further be implemented as a single I/O interface module that drives multiple I/O components.

The computing system 1204 executes program code that configures the processor 1302 to perform one or more of the operations described above. The program code includes the image processing module 1304. The program code comprising the image processing module 1304, when executed by the processor 1302, performs the functions described above for receiving the 3D person model, photo of the person, illumination condition data, and user inputs specifying selected apparel and generating a photorealistic image of the person wearing the selected apparel. The program code is resident in the memory 1316 or any suitable computer-readable medium and is executed by the processor 1302 or any other suitable processor. In additional or alternative embodiments, one or more modules are resident in a memory that is accessible via a data network, such as a memory accessible to a cloud service.

Memory 1316, I/O interface 1314, processor 1302, 3D sensor interface 1320, camera interface 1312, and ambient sensor 1308 are communicatively coupled within the computing system 1204 via a bus 1306.

In the following, further examples are described to facilitate the understanding of the invention:

### EXAMPLE 1

A method for generating an artificial picture (7) of a person (11) wearing a selectable piece of apparel, the method comprising the steps of:
a. providing a 3D person model (1) of at least a part of the person (11);
b. providing a photo (3) of the person corresponding to the 3D person model (1);
c. providing illumination condition data (2) relating to the photo (3);
d. selecting the piece of apparel; and
e. generating the artificial picture (7) as a combination of the photo (3) and a rendered 3D apparel model (21) of the selected piece of apparel, wherein rendering the 3D apparel model (21) considers the illumination condition data (2) and the 3D person model (1).

### EXAMPLE 2

The method of example 1, wherein method step e. comprises calculating a light layer (19) as a difference of:

the rendered 3D person model (1) based on the illumination condition data (2); and

the rendered 3D person model (1) based on the illumination condition data (2), wherein parts thereof, covered by the 3D apparel model (6), are set to invisible.

### EXAMPLE 3

The method of example 2, wherein setting to invisible comprises omitting, by a renderer, pixels not belonging to the 3D apparel model (21), and/or removing said pixels during post-production.

### EXAMPLE 4

The method of example 2 or 3, wherein step e. further comprises layering of the photo (3), the light layer (19), and the rendered 3D apparel model (21).

### EXAMPLE 5

The method of one of the preceding example, wherein considering the 3D person model (1) in step e. comprises applying the 3D apparel model (5) to the 3D person model (1) and/or applying light transport from the 3D person model (1) to the 3D apparel model (5).

### EXAMPLE 6

The method of example 5, wherein applying the 3D apparel model (5) to the 3D person model (1) further comprises applying geometrical properties of the 3D person model (1) to the 3D apparel model (5).

### EXAMPLE 7

The method of one of the preceding examples, wherein considering the illumination condition data (2) in step e. comprises applying the illumination condition data (2) to the 3D apparel model (5) and/or to the 3D person model (1).

### EXAMPLE 8

The method of one of the preceding examples, wherein step a. comprises at least one of the following steps:

providing the 3D person model (1) by means of a 3D scanner (13);

providing the 3D person model (1) by means of a depth sensor (15); or

providing the 3D person model (1) by means of photogrammetry.

### EXAMPLE 9

The method of one of the preceding examples, wherein the 3D person model (1) comprises a silhouette (23) and wherein the photo (3) comprises a silhouette (25) of the person (11), the method further comprising the step of bringing the silhouettes (23, 25) in conformity, if the silhouettes (23, 25) deviate from each other.

### EXAMPLE 10

The method of example 9, wherein the step of bringing the silhouettes (23, 25) in conformity further comprises:

extracting the silhouette (25) of the person (11) of the photo (3);

warping the 3D person model (1) such that the silhouette (23) of the 3D person model (1) matches the silhouette (25) extracted from the photo (3) and/or warping the photo (3) such that it matches the silhouette (23) of the 3D person model (1).

### EXAMPLE 11

The method of example 10, wherein warping comprises deforming one or both of the two silhouettes (23, 25).

### EXAMPLE 12

The method of example 11, wherein warping further comprises applying a physical simulation to avoid unnatural deformations.

### EXAMPLE 13

The method of one of the preceding examples, wherein the step of providing illumination condition data (2) is based on data gathered by an ambient sensor, preferably at essentially the same point in time when the photo (3) of the person (11) is taken.

### EXAMPLE 14

The method of example 13, wherein the ambient sensor comprises one of:

a spherical imaging system; or

a mirror ball.

### EXAMPLE 15

The method of one of the preceding examples, wherein the illumination condition data (2) comprises an environment map.

### EXAMPLE 16

The method of example 15, wherein the environment map comprises a simulated 3D model of a set in which the photo (3) has been taken.

### EXAMPLE 17

The method of examples 15-16, wherein applying the illumination condition data (2) comprises considering light transport from the environment map to the 3D person model (1) and to the 3D apparel model (6).

### EXAMPLE 18

The method of one of the preceding examples, wherein the 3D person model (1) comprises textures.

### EXAMPLE 19

The method of example 18, wherein the textures are based on one or more photos of the person (11) taken by one or more cameras (9).

### EXAMPLE 20

The method of example 19, further comprising the step of storing parameters of the one or more cameras (10), wherein the parameters (10) comprise at least one of:

the position of the camera;

the orientation;

the focal length.

### EXAMPLE 21

The method of example 21, wherein the parameters are suitable to calculate a reference point of view.

### EXAMPLE 22

The method of example 21, wherein step e. considers the reference point of view.

### EXAMPLE 23

The method of one of the preceding examples, wherein the photo (3) and the 3D person model (1) show the person in the same pose.

### EXAMPLE 24

An apparatus for generating an artificial picture (7) of a person (11) wearing a selectable piece of apparel, the apparatus comprising:
a. means (9, 13, 15) for providing a 3D person model (1) of at least a part of the person (11);
b. means (9) for providing a photo (3) of the person (11) corresponding to the 3D person model (1);
c. means for providing illumination condition data (2) relating to the photo (3);
d. means for selecting the piece of apparel; and
e. means for generating the artificial picture (7) as a combination of the photo (3) and a rendered 3D apparel model (21) of the selected piece of apparel, wherein rendering the 3D apparel model (6) considers the illumination condition data (2) and the 3D person model (1).

### EXAMPLE 25

The apparatus of example 24, wherein the means for providing a 3D person model (1) of at least a part of the person (11) comprises at least one of:

a 3D scanner (13);

a depth sensor (15); or

a plurality of photogrammetry cameras (9).

### EXAMPLE 26

The apparatus of one of the examples 24-25, wherein the means (9) for providing a photo (3) of the person (11) corresponding to the 3D person model (1) comprises a camera (9).

### EXAMPLE 27

The apparatus of one of the examples 25-26, wherein the camera (9) is one of the photogrammetry cameras (9).

### EXAMPLE 28

The apparatus of one of the examples 24-27, wherein the means for providing illumination condition data (2) relating to the photo (3) comprises an ambient sensor, wherein the ambient sensor comprises at least one of:

a spherical imaging system; or

a mirror ball.

### EXAMPLE 29

The apparatus of one of the examples 24-28, wherein the means for selecting the piece of apparel comprises at least one or more of:

a user interface;

a database; and/or

a file.

### EXAMPLE 30

The apparatus of one of the examples 24-29, wherein the means for generating the artificial picture (7) is configured to generate an artificial picture (7) of a person (11) wearing a selectable piece of apparel according to the method of any of the examples 1-23.

### EXAMPLE 31

A computer program comprising instructions for performing a method according to one of the examples 1-23.

### EXAMPLE 32

An artificial picture (7) of a person (11) wearing a selectable piece of apparel, generated according to the method of one of the examples 1-23.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A computer-implemented method for generating an image of a person wearing a selectable piece of apparel, the method comprising the steps of:
receiving, at a computing device, a first input comprising a photo of a person, a second input comprising a 3D person model of the person, and a third input comprising illumination condition data relating to the photo of the person, the illumination condition data indicating at least lighting conditions present during a time period when the photo of the person was captured;
receiving, at the computing device, a user input selecting a piece of apparel from a plurality of pieces of apparel, the piece of apparel associated with a 3D apparel model stored on a memory of the computing device; and
generating, by the computing device, an image of the person wearing the selected piece of apparel by:
generating a rendering of the 3D apparel model associated with the piece of apparel selected by the user input,
determining a light layer based on the 3D person model, the 3D apparel model, and the illumination condition data, and
combining the photo of the person, the rendering of the 3D apparel model, and the light layer to generate the image of the person wearing the selected piece of apparel.

2. The computer-implemented method of claim 1, wherein determining the light layer comprises:
determining a first model rendering comprising the 3D person model rendered with an application of the illumination condition data;
determining a second model rendering of the 3D person model rendered with the application of the illumination condition data and also rendered as virtually wearing the 3D apparel model, wherein parts of the 3D person model that are covered by the 3D apparel model are set to clear; and
calculating a difference of the first model rendering and the second model rendering, the difference corresponding to the light layer.

3. The computer-implemented method of claim 2, wherein setting the parts of the second model covered by the 3D apparel model to clear comprises omitting, via rendering software, pixels not belonging to the 3D apparel model.

4. The computer-implemented method of claim 3, wherein combining the photo of the person, the rendering of the 3D apparel model, and the light layer comprises composing the photo of the person as a background layer and composing the light layer and the rendering of the 3D apparel model as additional layers on top of the background layer.

5. The computer-implemented method of claim 1, wherein the rendering of the 3D apparel model is generated by applying, via the computing device, geometrical properties of the 3D person model to the 3D apparel model.

6. The computer-implemented method of claim 1, wherein the 3D person model comprises a first silhouette, wherein the photo of the person comprises a second silhouette, and wherein the method further comprises manipulating the 3D person model to conform the first silhouette to the second silhouette by deforming the 3D person model.

7. The computer-implemented method of claim 1, wherein the illumination condition data comprises an environmental map indicating a simulated 3D model of a set in which the photo was taken.

8. An apparatus configured to generate an image of a person wearing a selectable piece of apparel, the apparatus comprising:
a user interface configured to receive a user input selecting a piece of apparel from a plurality of pieces of apparel, the piece of apparel associated with a 3D apparel model;
an ambient sensor configured to capture illumination condition data indicating at least lighting conditions present during a time period when a photo is taken of a person;
a scanner configured to capture a 3D person model of a person;
a camera for capturing the photo of the person corresponding to the 3D person model; and
a computing device communicatively coupled to the ambient sensor, the scanner, and the camera, the computing device configured to execute program code to generate a rendering of the 3D apparel model associated with the piece of apparel selected by the user input, determine a light layer based on the 3D person model, the 3D apparel model, and the illumination condition data, and combine the photo of the person, the rendering of the 3D apparel model, and the light layer to generate an image wearing the selected piece of apparel.

9. The apparatus of claim 8, wherein the computing device is configured to execute program code to determine the light layer by:
determining a first model rendering comprising the 3D person model rendered with an application of the illumination condition data;
determining a second model rendering of the 3D person model rendered with the application of the illumination condition data and also rendered as virtually wearing the 3D apparel model, wherein parts of the 3D person model that are covered by the 3D apparel model are set to clear; and
calculating a difference of the first model rendering and the second model rendering, the difference corresponding to the light layer.

10. The apparatus of claim 9, wherein the computing device is configured to execute program code to set parts of the second model covered by the 3D apparel model to clear by omitting pixels not belonging to the 3D apparel model.

11. The apparatus of claim 10, wherein the computing device is configured to execute program code to combine the 3D person model, the rendering of the 3D apparel model, and the light layer by composing the photo of the person as a background layer and composing the light layer and the rendering of the 3D apparel model as additional layers on top of the background layer.

12. The apparatus of claim 8, wherein the computing device is configured to execute program code to generate the rendering of the 3D apparel model by applying geometrical properties of the 3D person model to the 3D apparel model.

13. The apparatus of claim 1, wherein the illumination condition data comprises an environmental map indicating a simulated 3D model of physical surroundings in which the photo was taken.

14. A non-transitory computer-readable medium with program code executed thereon, wherein the program code is executable to perform operations comprising:
receiving a first input comprising a photo of a person, a second input comprising a 3D person model of the person, and a third input comprising illumination condition data relating to the photo of the person, the illumination condition data indicating at least lighting conditions present during a time period when the photo of the person was captured;
receiving a user input selecting a piece of apparel from a plurality of pieces of apparel, the piece of apparel associated with a 3D apparel model stored on a memory of the computing device; and
generating an image of the person wearing the selected piece of apparel by:
generating a rendering of the 3D apparel model associated with the piece of apparel selected by the user input,
determining a light layer based on the 3D person model, the 3D apparel model, and the illumination condition data, and
combining the photo of the person, the rendering of the 3D apparel model, and the light layer to generate the image of the person wearing the selected piece of apparel.

15. The non-transitory computer-readable medium of claim 14, wherein determining the light layer comprises:
determining a first model rendering comprising the 3D person model rendered with an application of the illumination condition data;
determining a second model rendering of the 3D person model rendered with the application of the illumination condition data and also rendered as virtually wearing the 3D apparel model, wherein parts of the 3D person model that are covered by the 3D apparel model are set to clear; and
calculating a difference of the first model rendering and the second model rendering, the difference corresponding to the light layer.

16. The non-transitory computer-readable medium of claim 15, wherein setting the parts of the second model covered by the 3D apparel model to clear comprises omitting pixels not belonging to the 3D apparel model.

17. The non-transitory computer-readable medium of claim 16, wherein combining the 3D person model, the rendering of the 3D apparel model, and the light layer comprises composing the photo of the person as a background layer and composing the light layer and the rendering of the 3D apparel model as additional layers on top of the background layer.

18. The non-transitory computer-readable medium of claim 14, wherein the rendering of the 3D apparel model is generated by applying, via the computing device, geometrical properties of the 3D person model to the 3D apparel model.

19. The non-transitory computer-readable medium of claim 14, wherein the 3D person model comprises a first silhouette, wherein the photo of the person comprises a second silhouette, and wherein the method further comprises manipulating the 3D person model until to conform the first silhouette to the second silhouette by warping or deforming the 3D person model.

20. The non-transitory computer-readable medium of claim 14, wherein the illumination condition data comprises an environmental map indicating a simulated 3D model of physical surroundings in which the photo was taken.
